(19) United States
(12) Patent Application Publication
(10) Pub. No.: US 2012/0098344 A1
(43) Pub. Date: Apr. 26, 2012

(54) PHOTOVOLTAIC UNITS, METHODS OF OPERATING PHOTOVOLTAIC UNITS AND CONTROLLERS THEREFOR

(75) Inventors: Hendrik Johannes Bergveld, Eindhoven (NL); Franciscus A. C. M. Schoofs, Valkenswaard (NL); Gian Hoogzaad, Mook (NL)

(73) Assignee: NXP B.V., Eindhoven (NL)

(21) Appl. No.: 13/318,730

(22) PCT Filed: Jul. 10, 2009
(86) PCT No.: PCT/IB09/53001

§ 371 Date: Nov. 3, 2011

(30) Foreign Application Priority Data
May 8, 2009 (EP) 09159824.3
Jul. 10, 2009 (IB) PCT/IB2009/053001

(51) Int. Cl. H02J 9/00

(52) U.S. Cl. 307/65; 307/64

(57) ABSTRACT

The present invention relates to the field of photovoltaic systems with solar cell (s) or modules having insolation differences or mismatch. Each solar module is formed by placing a large number of solar cells in series. The PV system is then formed by placing a number of solar modules in series in a string and sometimes by placing multiple strings of series-connected solar modules in parallel, depending on the desired output voltage and power range of the PV system. In practical cases, differences will exist between output powers of the solar cells in the various modules, e.g. due to (part of) the modules being temporarily shaded, pollution on one or more solar cells, or even spread in solar-cell behaviour that may become worse during aging. Due to the current-source-type behaviour of solar cells and their series connection these differences will lead to a relatively large drop in output power coming from the PV system. This invention addresses this problem by adding DC-DC converters (803) on a single or multiple solar-cell level that source or sink difference currents thereby increasing the output power of the complete PV system. In embodiments, the efficiency of photovoltaic systems with solar cell (s) or modules is improved by compensating for output-power loss caused by insolation difference and mismatch.

### FIELD OF THE INVENTION

This invention relates to photovoltaic units. It further relates to methods for operating photovoltaic units, and to controllers configured to operate such methods.

### BACKGROUND OF THE INVENTION

A photovoltaic cell (hereinafter also referred to as a solar cell) is a device which directly converts light such sunlight into electricity. A typical such device is formed of a p-n junction in a semiconductor material. In operation, one surface of the device is exposed to light typically through an anti-reflective coating and protective material such as glass. Contact to this surface is made by a pattern of conductive fingers typically of a metal such as aluminium. Electrical contact to the other side of the p-n junction is typically provided by a continuous metal layer.

Photovoltaic (PV) systems, typically made of several hundreds of solar cells, are increasingly used to generate electrical energy from solar energy falling on solar modules. Generally, each solar module is formed by placing a large number of solar cells in series. A PV system is then formed by placing a number of solar modules in series, to create a string and sometimes by placing multiple strings of in-series-connected solar modules in parallel, depending on the desired output voltage and power range of the PV system.

In practical cases, differences will exist between output powers of individual solar cells in the various modules, e.g. due to (part of) the modules being temporarily shaded, pollution on one or more solar cells, or even spread in solar cell behaviour—for instance due to manufacturing variations or to differences in the rate of degradation of performance of cells during aging. Due to the current-source-type behavior of solar cells and their series connection these differences will lead to a relatively large drop in output power coming from a PV system, as will be explained in more detail herebelow.

FIG. 1(a) shows the equivalent circuit 100 which is most often used to model the performance of a solar cell (the so-called single-diode model). A current source 101 corresponding to the photo-generated current (also referred to hereinafter as insolation current) Iᵢₙₛ is in parallel with a diode 102 and shunt (that is, parallel) resistance Rp at 106. That part of Iᵢₙₛ which does not flow through the diode or shunt resistance flows to an output node via the low-ohmic series resistance Rs 103 (typically a few mΩ per cell). Some internal leakage occurs via the high-ohmic shunt resistance Rp (typically in a kΩ to MΩ range).

Its accompanying I-V characteristic is shown in FIG. 1b, for the case where the photo-generated current Iᵢₙₛ is zero (curve 1) corresponding to no irradiation, and non-zero (curve 2) corresponding to an irradiated cell. As shown in the un-irradiated case, the IV characteristic is that of a diode with shunt and series resistances; introduction of irradiation due to eg insolation translates the IV characteristic downwards, into the IV (that is, fourth) quadrant of the IV plane. Normally, the (IV-quadrant) part of the characterisitic which is of most interest in photovoltaics is shown inverted, as can be seen on FIG. 1(c) at 2′ along with the corresponding power-voltage (P-V) curve 3.

When the cell is shorted, an output current I of a cell equals the value of the current source (Iᵢₙₛ=short-circuit current Isc in the I-V characteristic in FIG. 1(c). When left open-circuit, current lins will flow mostly into the diode leading to an open-circuit voltage Voc, which for a polysrystalline silicon cell may typically be roughly 0.6 V, see FIG. 1c. Basically, the output current is linearly proportional to the amount of incoming light for light conditions exceeding 100 W/m², which is typical for most cases during outdoor use.

As can be seen, there is a single point on the IV curve which produces maximum power (at the voltage corresponding to the maximum power peak Pm of the P-V curve). In the Figure are shown short-circuit current Isc and open-circuit voltage Voc, along with the current (Imp) and voltage (Vmp) at the maximum power point (MPP). Thus Pm=Imp*Vmp, and is related to the product of Isc and Voc by means of the fill factor FF: Pm=Isc*Voc*FF.

FIG. 1(d) shows the change (in the IV-quadrant) of the IV characteristic with varying insolation φ. The short-circuit current Isc scales linearly with increasing illumination φ as shown at Isc^{φ1}, Isc^{φ2} and Isc^{φ3}. The open circuit voltage Voc increases slowly with increasing insolation φ, as shown at Voc^{φ1}, Voc^{φ2} and Voc^{φ3}.

FIG. 2 shows at (a) the I-V characteristic and at (b) the P-V characteristic of a typical solar module with 36 solar cells in series, as a function of incoming light and temperature. The degradation with increasing temperature of open-circuit voltage (where each of the IV and PV characteristic crosses the voltage axis), and maximum power voltage (shown as Vm) is apparent, as is the linearly increasing short-circuit current with insolation intensity (from 20 mW/cm², through 60 mW/cm², to 100 mW/cm²

Since a cell's output current depends e.g. on the amount of incoming light (insolation) and further cell behaviour is also temperature dependent, as a consequence the current and voltage value at which maximum power is obtained from a cell varies with environmental conditions. Therefore, in order to obtain a maximum output, in any practical solar system preferably this maximum power point needs to be continuously updated, which is referred to as Maximum-Power-Point Tracking (MPPT). In a sub-optimal configuration this is usually performed for all solar cells simultaneously.

As already mentioned, in order to provide useful power, in most applications solar cells are connected in series, in a module or sub-unit. The possible resulting IV characteristics are illustrated schematically in FIG. 15. Since the cells are series connected, the current through each cell must be the same. FIG. 15(a) shows the situation where each cell has the same characteristic, under the same illumination conditions. Then, the module IV characteristic is simply a stretched version of the individual cell characteristic: If each cell has short circuit current, open circuit voltage, max power voltage and max power of, respectively, Isc1, Voc1, Vmp1 and Pmax1, then the module has respective short circuit current, open circuit voltage, max power voltage and max power of Isc1, n*Voc1, n*Vmp1 and n*Pmax1.

However, if one of the cells has a lower short circuit current Isc2 (and open circuit Voc2), as shown schematically, and slightly simplified, in FIG. 15(b), then, when the other cells are producing current Isc1, that cell will be driven into reverse bias until it starts to break down, (with a reverse bias of Vbd). The current-matching constraint results in an IV characteristic with a further “knee”, which lies to the left of the original max-power knee, by a voltage of Vdb. To the left of this further knee, the characteristic slopes up to Isc1 with a slope dependant on the reverse breakdown of the lower current cell; between this knee and the original Vmp (ie n*Vmp1), the current is Isc2. The module open circuit is (n−1)*Voc1+Voc2, which is approximately n*Voc1, and the right-hand max power point is still approximately at n*Vmp1.

As shown, the lower current cell starts to reverse breakdown with a sufficiently low Vbd, that the further “knee” is to the right of the axis. However, where the cell has a high Vbd, the knee can be to the left of the axis. This is shown, for the IV-quadrant, schematically in FIG. 15(c).

In practice, many reasons exist why an output current of one cell will not be equal to that of another. Examples are shading, local contaminations on a module (e.g. bird droppings, leafs, etc), and spread between cells (aggravated by aging). The most prominent is that of (partial) shading, where one or more cells in one or several modules receive less incoming light than others, leading to lower lins values than that of other cells. In practice, shading of a cell may lead to 40-50% less incoming light than cells that have no shadow across them. In practical systems, partial shading may only occur during a certain part of the day and most of the day all cells will be in bright sunlight. Some examples of modules 500, which are partially shadowed by other module shadows 501 or by antenna shadows 502 in practical PV systems are shown in FIG. 5. As can be seen, only small portions of the modules therein are in the shade. As will be explained below, this will lead to a relatively large decrease in output power of the PV system in question.

FIG. 16(a) shows the IV characteristic of a similar module (or segment), including a lower current cell with a high reverse breakdown. Where there is an external constraint (such as a series-connected module) forcing Isc1 through the module, the whole module could be forced into reverse bias. In conventional modules, this is prevented by the inclusion of a “bypass diode” in anti-parallel with the module. If the module is driven into reverse bias, the bypass diode (which then becomes forward biased) turns on, and shunts the excess current. The reverse bias across the module is limited to the diode's forward bias Vf, and the lower-current cell does not reach Vbd. Thus, where the string current through the module forces to operate at a high current Ist (shown at 61) instead of the module operating at the reverse breakdown voltage of the lower-current cell (ie point B in the Figure), it operates at the by-pass diode's forward voltage (point A).

Now, however, instead of producing the maximum possible power which could be available from this module (of approximately [n*Vmp2]*Imp2, shown at point C in FIG. 16(a)), the module consumes a power of approximately Isc2*Vf. This corresponds to a significant drop in efficiency for the photovoltaic system as a whole. The bypass diode thus protects the lower-current cell from potentially damaging high reverse bias, (the so-called “hot-spot” phenomenon), and at the same time limits, but does not eliminate, the power loss in the system which results from the current mis-match.

Addition of DC-DC or DC/AC converters (micro inverters) on module level will help to reduce a decrease in output level. An example thereof is a concept by National Semiconductors (Solar Magic) wherein all power is fed through DC-DC converters that add their output powers together in a series string. This form of converter may thus be termed a “sigma converter”, as the complete power from a module is converted, and the power from each module is summed at the outputs of the DC-DC converters. As they have to convert all the power, all the time, they are relative large and expensive, and prone to failure.

There is an ongoing need to provide an alternative arrangement wherein more of the potentially available power, from modules with cells having mis-matched currents, can be realised.

### SUMMARY OF THE INVENTION

It is an object of the present invention to provide a photovoltaic unit which does not suffer from above problems to the same extent.

According to an aspect of the present invention, there is provided a photovoltaic unit comprising a first sub-unit and a second sub-unit series-connected with the first sub-unit, wherein the first sub-unit and second-sub-unit each comprise either a single solar cell or a series-connected plurality of solar cells, and wherein the first sub-unit further comprises a supplementary power unit connected in parallel with the respective solar cell or plurality of solar cells. The sub-unit may thereby be protected against unnecessary performance degradation due to shadowing or otherwise lower insolation. A photovoltaic unit may be without limitation one or more panels or part of a panel, or one or more modules or part of a module. Similarly, a sub-unit may be, without limitation, a panel or part of a panel, a module or part of a module, a segment of series connected cells, or even a single cell.

In embodiments, the supplementary power unit comprises at least part of a DC-DC converter. Another part of the DC-DC converter may comprise part of another sub-unit, or of a central control system or inverter. Preferably, the DC-DC converter is configurable to at least one of source and sink current in parallel with the first sub-unit's respective solar cell or plurality of solar cells. A DC-DC converter can operate as an effective power unit, and typically either can be configured to source (that is, supply a positive current), or can be configured to sink (that is, supply a negative current), or both. Since the converter is only converting a difference between the sub-units' currents, it may conveniently be termed a delta converter, and may be dimensioned for lower power than prior art sigma converters.

In embodiments, the first sub-unit is a module comprising between 4 and 72 solar cells, and in preferred embodiments the first sub-unit is a segment comprising between 18 and 24 solar cells, there being 3 or 4 such segments per module, and the module may then be the photovoltaic unit.

Such modules, which may also be termed panels, typically acts as a “building block” of a photovoltaic system. In many conventional photovoltaic systems, a bypass diode is connected in parallel with such a module or segment, and advantageously, embodiments of the invention render such a bypass diode unnecessary.

In embodiments, the second sub-unit further comprises a second supplementary power unit. The second sub-unit can thereby by protected against unnecessary performance degradation due to shadowing or otherwise lower insolation.

In embodiments, the second supplementary power unit comprises at least part of a second DC-DC converter. Preferably the second DC-DC converter is configurable to at least one of source and sink supplementary current.

In embodiments, the DC-DC converter is a switched-mode converter. The DC-DC converter may be a flyback converter. However, due to its output diode, a flyback converter is a unidirectional converter; preferably, the DC-DC converter is a bidirectional converter. The same DC-DC converter may then be used to either source or sink current; where a uni-directional converter is required, a complementary DC-DC converter may be required to enable both sourcing and sinking of current.

Preferably, the bidirectional converter is a half-bridge converter. Control of this type of converter is particularly convenient.

According to another aspect of the present invention, there is provided a photovoltaic array comprising a plurality of photovoltaic units as discussed above.

According to a further aspect of the present invention that there is provided a method of operating a photovoltaic unit comprising a first sub-unit comprising at least one solar cell, a second sub-unit series-connected with the first sub-unit and comprising at least one solar cell, and a supplementary power unit connected in parallel with the at least one solar cell of the first sub-unit, the method comprising: determining the difference between a photo-generated current produced by the first sub-unit and a photo-generated current produced by the second sub-unit, and controlling the supplementary power unit to supply current in dependence on the difference between the photo-generated current produced by the first sub-unit and the photo-generated current produced by the second sub-unit.

In embodiments the supplementary power unit is controlled to source current when the photo-generated current produced by the first sub-unit is less than the photo-generated current produced by the second sub-unit and to sink current when the photo-generated current produced by the first sub-unit is greater than the photo-generated current produced by the second sub-unit.

Thus the supplementary power unit acts as a current compensator for the first sub-unit, such that the sum of the photo-generated current through the at least one (first) solar cell and the compensation current sourced (or sunk) by the supplementary power unit approaches or is approximately equal to the current through the second sub-unit.

In embodiments the method further comprises determining the maximum power operating point of the first sub-unit whilst the supplementary power unit is not supplying current; determining the maximum power operating point of the second sub-unit whilst the supplementary power unit is not supplying current, and controlling the supplementary power unit to either source or sink current such that at least one of the first and second sub-units operates closer to its respective maximum power operating point than it does when the supplementary power unit is not supplying current. By operating the sub-unit closer to its maximum power operating point, less of the power generated by that sub-unit is a wasted as heat.

In embodiments the step of controlling the supplementary power unit to either source or sink current such that at least one of the first and second sub-units operates closer to its respective maximum power operating point than it did when then supplementary power unit is not supplying current comprises controlling the supplementary power unit to either source or sink current such that each of the first and second sub-units operates substantially at its respective maximum power operating point. The method thereby reduces or almost eliminates losses in each sub-unit due to mismatch between operating points.

In embodiments wherein the photovoltaic unit comprises a further sub-unit comprising at least one solar cell and a further supplementary power unit connected in parallel with the at least one solar cell, which further sub-unit is series connected with the first and second sub-unit, the method may further comprise controlling a supplementary power unit to supply current in dependence on a photo-generated current of the further sub-unit.

In embodiments wherein the photovoltaic unit comprises a plurality of sub-units, each of which comprises at least one solar cell, and a supplementary power unit connected in parallel with the at least one solar cell, the method may further comprise controlling each supplementary power unit such that each at least one solar cell operates substantially at its maximum power operating point. Losses from multiple sub-units which are either part-shaded, or otherwise producing lower photo-generated current, may thereby be reduced or even eliminated.

In embodiments each supplementary power unit is controlled such that the sum of the photo-generated current from the sub-unit and the current supplied by the respective supplementary power unit is substantially equal to the average of the photo-generated currents of the sub-units when none of the supplementary power units are supplying current.

Furthermore, in embodiments the total power supplied by the supplementary power units is substantially zero. Power is thereby redistributed between the subunits. In this case, the supplementary power units need be rated sufficient only to convert the maximum foreseeable difference in current between a sub-units and the average over the whole of total unit (or string). Lower (power) rated components may therefore be used resulting in potentially substantial cost savings.

According to a yet further aspect of the present invention, there is provided a controller configured to operate a method as just described above.

A controller, which may be central controller, may be used to optimize the output, e.g. in terms of number of active modules, actually delivering power. Such a controller may calculate, while the system is operating, i.e. at any point in time, an optimum combination of active current compensators, both in terms of number of active current compensators and in terms of numbers of current compensators delivering a current and removing a current. As such, a maximum output of a system, comprising one ore more modules, may be provided.

A monitor device may be used to monitor individual performance of cells, segments, modules etc. As such it may be used to provide input to optimize performance of the present module.

These and other aspects of the invention will be apparent from, and elucidated with reference to, the embodiments described hereinafter.

### BRIEF DESCRIPTION OF DRAWINGS

Embodiments of the invention will be described, by way of example only, with reference to the drawings, in which

FIG. 1 shows at (a) a diagram of an equivalent circuit model of a solar cell; at (b) an I-V characteristic of a solar cell under insolation and in the dark; at (c) the IV-quadrant IV characteristic in more detail, and at (d) the effect of varying the insolation φ;

FIG. 2 shows at (a) the I-V characteristic and at (b) the P-V characteristic of a typical solar module with 36 solar cells in series as a function of incoming light and temperature;

FIG. 3 shows drawings of various categories of PV system: (a) stand-alone; (b) residential; (c) commercial, and (d) solar plant;

FIG. 4 is a schematic of a 60-cell solar module, having 3 segments, and including 3 bypass diodes placed in a junction box attached to the backside of the solar module;

FIG. 5 illustrates partial shading in practical PV systems;

FIG. 6 shows a diagram of a segment or sub-unit of 20 cells, one of which is shaded, with a bypass diode across them;

FIG. 7 is a diagram of a known arrangement of modules connected to a series arrangement of DC-DC converters;

FIG. 8 is a schematic of two solar cells in series and each having a supplementary power unit connected in parallel, according to embodiments of the invention;

FIG. 9 is an illustration of possible scenarios to source or sink currents to cancel differences between output currents of sub-units of solar cells.

FIG. 10 is a schematic of an arrangement of series-connected segments, each having a supplementary power unit connected in parallel, according to embodiments of the invention;

FIG. 11 is a histogram of output powers of modules in a string, showing the power delivered by modules comprising the string in relation to the power converted by each module's delta DC-DC converter;

FIG. 12 is a schematic of a PV system having delta DC-DC converters supplied from intermediate DC-DC converter;

FIG. 13 shows, schematically, an embodiment of a control system for a PV system having delta converters connected to communication bus;

FIG. 14 is a simplified circuit diagram of a bidirectional DC-DC converter with isolated input and output terminals;

FIG. 15 shows pictorially at (a), (b) and (c), possible resulting IV characteristics resulting from series connections of n solar cells;

FIG. 16(a) shows the IV characteristic of a segment of solar cells, one of which has a lower photo-generated current than the others, with and without a bypass diode; and

FIG. 16(b) shows, pictorially, the IV characteristic of a module operating in conjunction with a supplementary power unit.

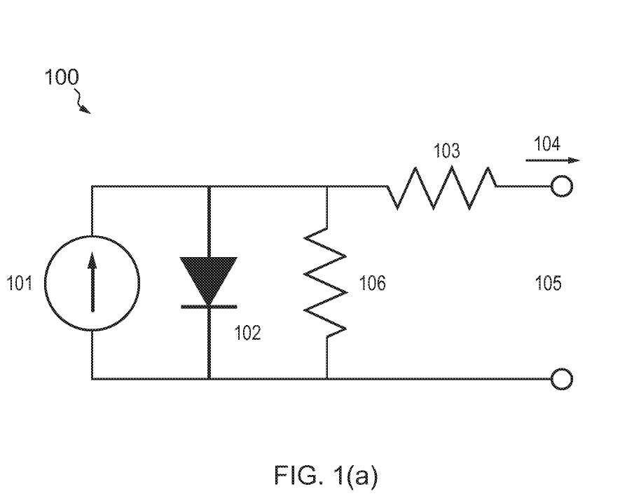

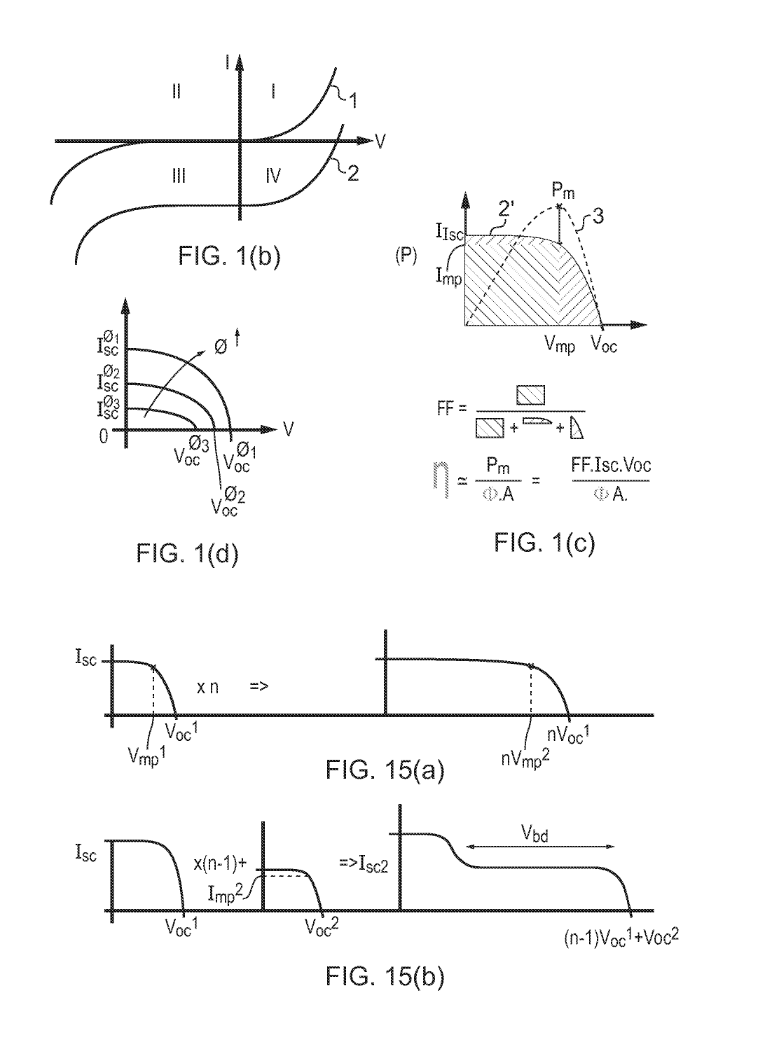

It should be noted that the Figures are diagrammatic and not drawn to scale. Relative dimensions and proportions of parts of these Figures have been shown exaggerated or reduced in size, for the sake of clarity and convenience in the drawings. The same reference signs are generally used to refer to corresponding or similar feature in modified and different embodiments

### DETAILED DESCRIPTION OF EMBODIMENTS

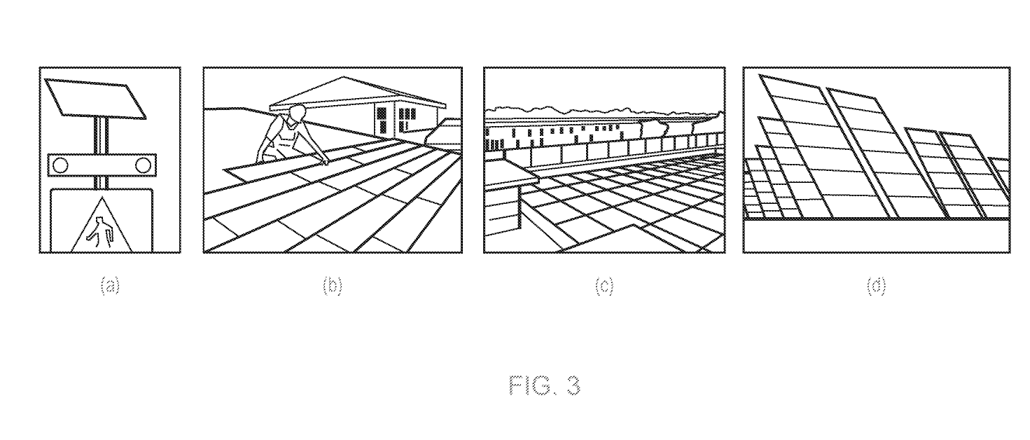

A conventional arrangement for a PV system is shown in FIG. 4. A solar module 400 consists of perhaps 54-72 cells 100 in series, typically arranged in a meander-type fashion with a width 402 of 9-12 cells and one bypass diode 401 per segment of 18-24 cells. The number of cells per bypass diode is typically coupled to the breakdown voltage of the solar cells used. A segment 403 comprising one series of solar cells and a bypass diode 401 is indicated as well. The 3 diodes in FIG. 4 are typically placed in a junction box 404 with a heat sink that is placed on the backside of each module.

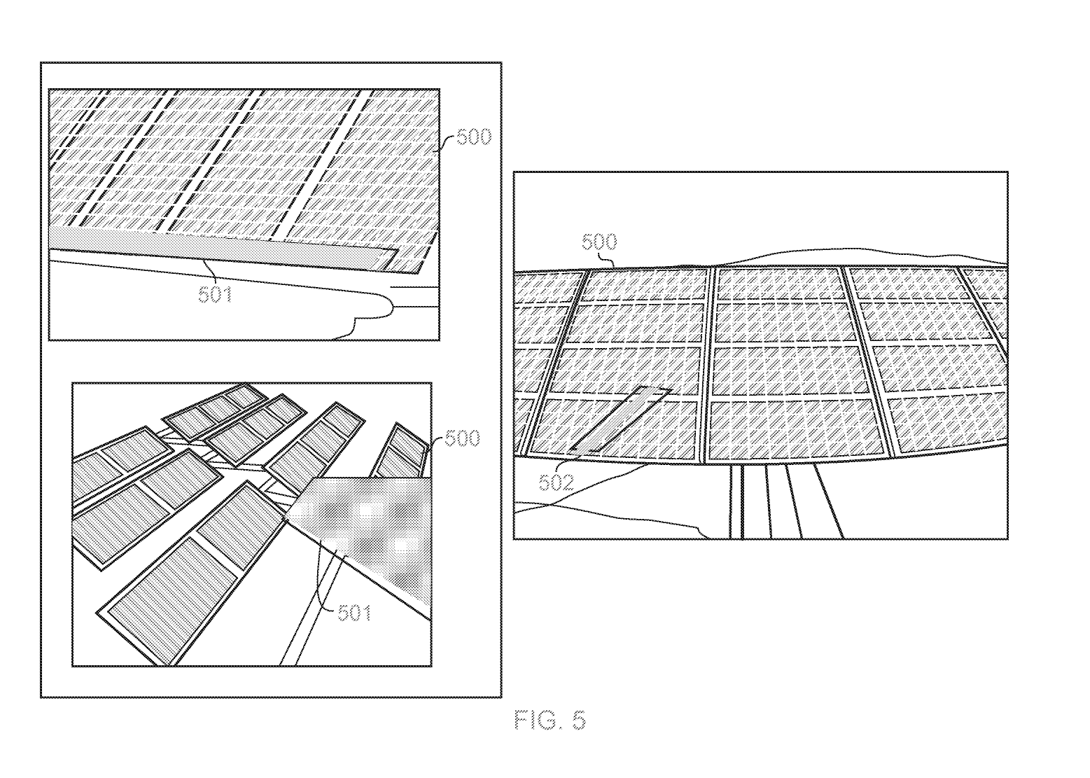

Conventional modules exhibit a signficant decrease in output power due to sub-optimum performance of one or more PV solar cells present, e.g. due to shading, breakage, electrical disconnects, etc . In order to understand why e.g. shading of even a single or a few cells may lead to a relatively large decrease in output power of a PV system, consider a fragment of a module—also described herein as a segment or sub-unit—as depicted in FIG. 6. One bypass diode 401 is placed across 20 cells 100. An insolation level of 1000 W/m2 is assumed. Neglecting shunt and series resistances, the cells are each modelled by current source 101 in parallel with diode 102. Each cell has an assumed Iᵢₙₛ value of 8 A (shown at 604), and Vmp of 0.5V. However, one cell has been assumed to be completely malfunctioning e.g. due to shading, which relates to an extreme case where there is zero (no) photo-generated current (shown at 605). In fact, this situation arises when one cell is e.g. completely covered, e.g. with a bird dropping or leaf. Provided that the reverse breakdown voltage of this cell is sufficiently high to withstand the sum of the individual open-circuit voltages 603 of the remaining cells, (effectively) no current will flow through the series-connected cells. However, in a typical module, there is a string current Istring generated from the cells in the other segments: as a result, the whole of the current Istring 601 will flow through the bypass diode present. The voltage 606 across this group of 20 cells is thus not the possible maximum value of 20*0.5 V=10 V at MPP, but only −0.6 V (606), being the forward voltage across bypass diode 401; as a consequence, energy is being wasted instead of being generated. Note that Istring is determined by a central MPPT controller in a central inverter that tries to find an optimum point for all modules simultaneously.

So, in this case, although only one single cell is not able to and does not deliver power, the power of 20 cells is wasted (as heat, since all the photo-generated current for each cell is shunted back through that cell's diode. Note that in FIG. 6 a reverse voltage 602 across a sub-optimum functioning cell such as a shaded cell becomes 19*Vcell+Vbypass=20*0.6 V=12 V, with 0.6 V being the open circuit voltage 603 across the non-shaded cells with lins current of 8 A (604) flowing completely in diode 102.

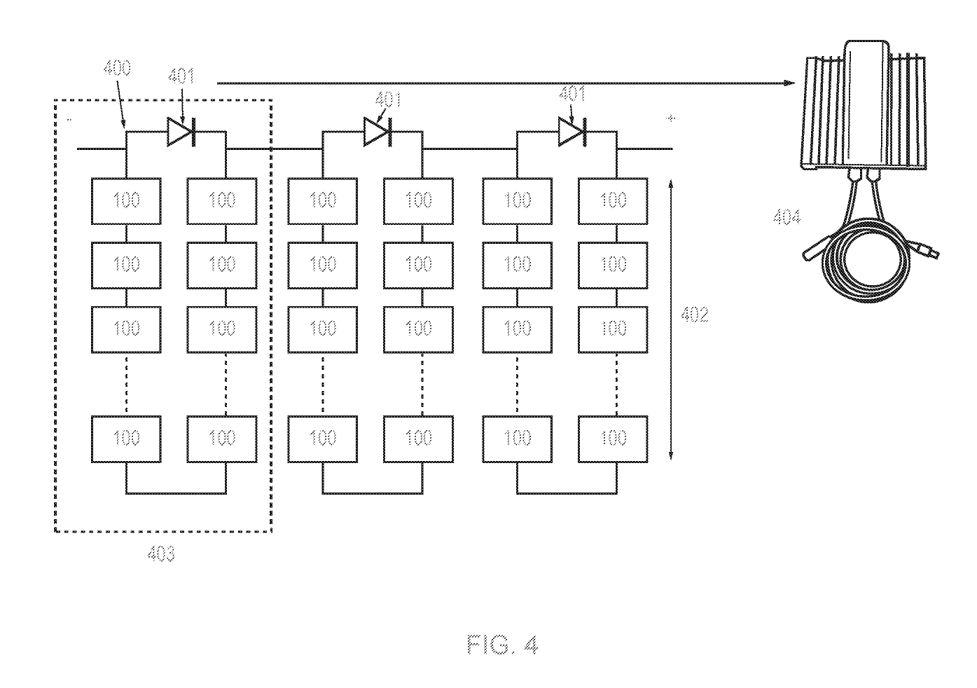

In more extreme cases where e.g. in case of a 60-cell module only a few cells are shaded on a complete module, but in each segment (403) of e.g. 20 cells with parallel bypass diode (401) there is at least one shaded cell, the complete module will be effectively bypassed when other modules in the string are not shaded and dictate the MPP current at levels higher than the output current of the shaded cells. As a consequence the resulting module voltage in the string will be −1.8 V (3 conducting bypass diodes in series) instead of +30 V! In FIG. 5, such a situation actually occurs for the shaded module shown in the PV system on the right-hand side. Here, an antenna shadow 502 falls across the module where the rows are organized such that the antenna shadow covers a few cells in each segment (403) in the module. Therefore, the complete module is bypassed in the string.

In PV systems with module strings in parallel, the effects can be even worse. In cases where in one string some cells are shaded, one complete string may fail to deliver output power. The reason in this case is that strings in full sunlight will dictate the voltage across a partially shaded string. Assuming that current from the non-shaded string will not flow in the shaded string due to a string diode preventing current from flowing into the string, the voltage across the shaded string may not be high enough to be able to deliver current to the system through the string diode. In all cases, the fact that the

MPP is installed centrally ensures that in the found optimum point whole modules will not take part in generating power, even if only a few solar cells are covered/shaded.

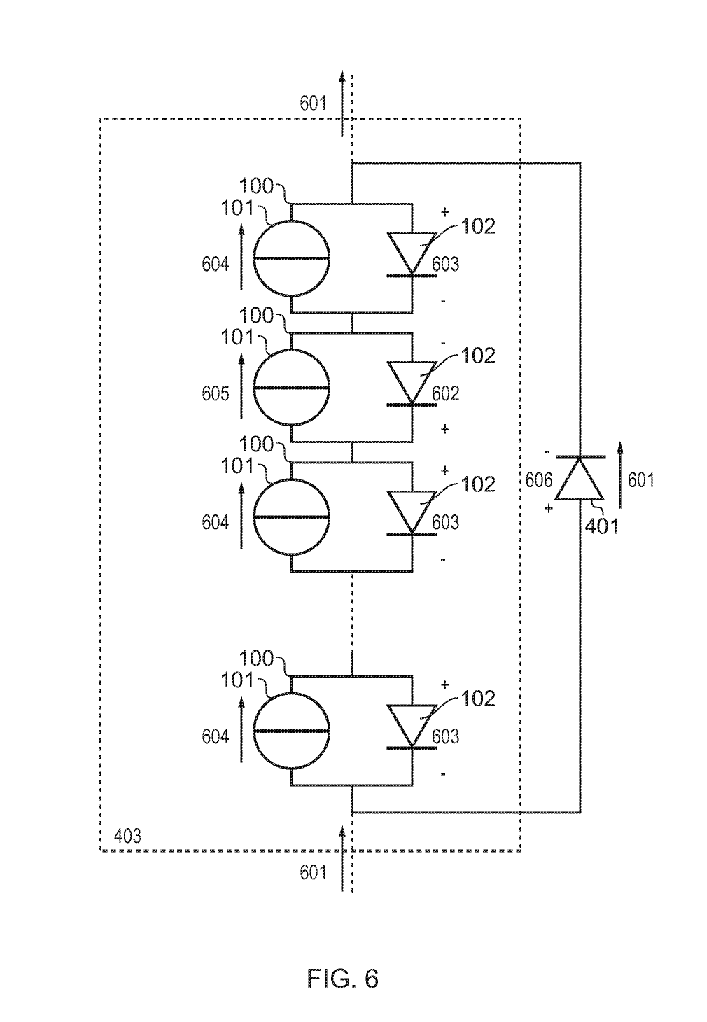

One known arrangement which is used in order to mitigate these problems is shown in FIG. 7. The solution is used for instance in National Semiconductor's Solar Magic™ system, and is based on module-level DC-DC converters. The basic idea is that modules are no longer connected directly in series, but as shown in FIG. 7, each module 400 is connected to its own DC-DC converter 705, the outputs 703 of which are placed in series again. Each DC-DC converter ensures the connected solar module operates at its individual MPP, thus the DC-DC converter's Iin is set to the associated module's Imp 702, and it's Vin 701 to the associated Vmp. Therefore, even if a module is shaded, it can still contribute to the output power of the string, since it can operate at a lower current because the module current has been decoupled from the string current. This has a positive impact on the total output power in case of differences between module output powers. At its output, the DC-DC converter adds this power to that of the others, simply by adapting its output voltage (703) to the current that is flowing in the string (601) of series-connected DC-DC converters. Since all output powers are added, these DC-DC converters could also be dubbed ‘sigma’ converters. Note that the central inverter (DC/AC) remains in place in this case. By adding DC-DC converters per module, the output power 704 coming from the PV system and fed through the inverter is increased, relative to the conventional system without sigma converters, in case of partial shading or other sources of differences.

Alternatives arrangements include DC-DC converters at a string level, or DC-AC converters at a module level (micro inverters).

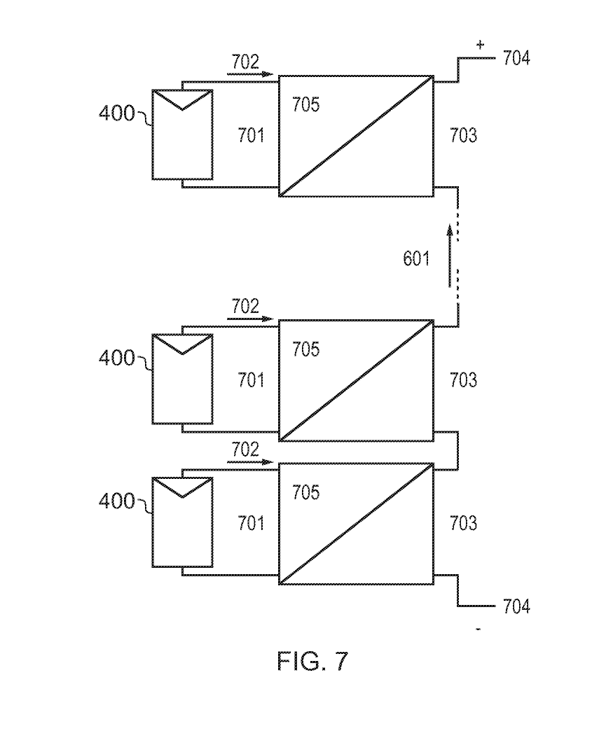

An embodiment of the present invention is illustrated pictorially in FIG. 8. FIG. 8 shows two cells 100 connected in series, each having a supplementary power unit 803. The two solar cells have different insolation levels with associated different photo-generated currents I_{ins,1} shown at 801 and I_{ins,2} shown at 802.

As a result of the series connection, the lower of these two insolation currents would, according to the prior art, determine the output current, and thus the output power of the two series-connected cells. However, as shown in FIG. 8, a supplementary power unit (in this case current generator or current compensator 803) is connected in parallel with each cell. The current compensator which is in parallel with the cell having the lower photo-generated current sources additional current, in parallel with that cell. Alternatively or in addition, the current compensator in parallel with the cell having the higher photo-generated current sinks excess current, in parallel with that cell.

The effect of this is that this part of the PV system now behaves like a system wherein all insolation currents of the solar cells are the same. Therefore, the negative effects of insolation differences between cells have been effectively compensated for. This is expressed as follows:

I_{ins,1}+ΔI₁=I_{ins,2}+ΔI2

Also shown are different compensation-current values ΔI1 (804) and ΔI2 (805), solar cells (100), and the string current (601) imposed by the central MPPT controller.

The current sources per cell depicted in FIG. 8 are implemented with DC-DC converters (803). In its most versatile form, the current sources are bidirectional—and thus can also operate as current sinks, or more generally, are supplementary power units. Other implementations with unidirectional sources are also possible.

The associated power required for adding (sourcing) or made available by subtracting (sinking) currents at the valid voltage level is either subtracted from or delivered to the PV system. Since the DC-DC converters compensate differences between cells, these converters can be named delta converters, as opposed to the sigma converters described above in previously known systems.

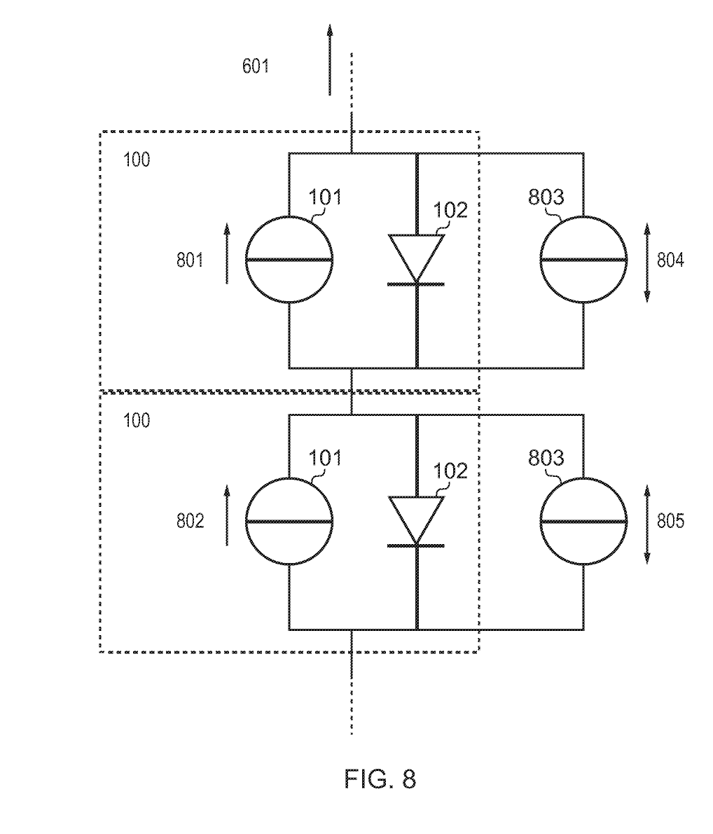

FIG. 9 illustrates possible scenarios for the example case where I_{ins,1} (801)>I_{ins,2} (802). Further ΔI 803 and Iᵢₙₛ 101 values are shown. In scenario 901, only current is added in parallel to solar cell 2, so ΔI1=0 (condition 904) and ΔI2=I_{ins,1}−I_{ins,2}>0 (condition 905). Then this segment of the module provides the higher current level, and power is consumed by one supplementary power unit. In scenario 902, only current is sunk from solar cell 1, so ΔI1=I_{ins,2}−I_{ins,1}<0 (condition 906) and ΔI2=0 (condition 907). In this scenario, the supplementary power unit thus generates power. In scenario 903, current is subtracted from solar cell 1 and current is added to solar cell 2, so ΔI1=(I_{ins,2}−I_{ins,1})/2<0 (condition 908) and ΔI2=(_{ins,2})/2>0 (condition 909). In this case, one supplementary power unit consumes power, which to a first approximation matches the power generated by the other supplementary power unit; there is no net power gain or loss.

The net result in all cases is that the “effective” currents of the cells are equal. In scenario 901, the net current equals I_{ins,1} (801) in scenario 902 it is I_{ins,2} (802) and in scenario 903 it is (I_{ins,1}+I_{ins,2})/² (910).

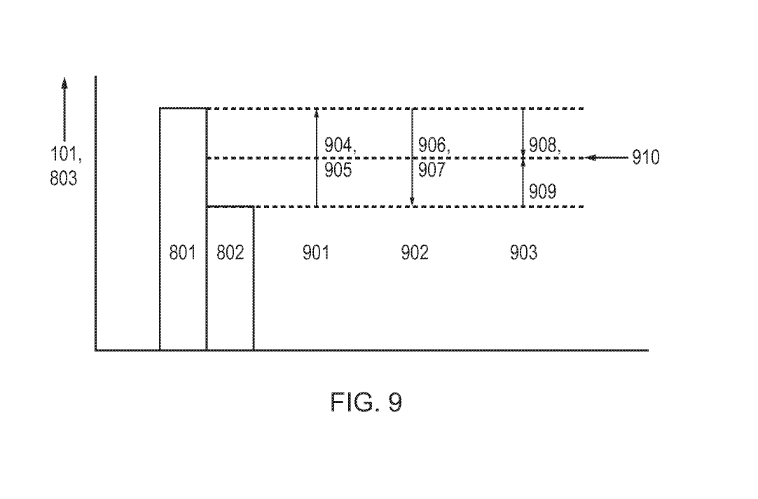

FIG. 10 shows a similar arrangement. In this case, though, a supplementary power unit 1006 or current compensator is not connected in parallel with each cell 100, as was the case from the previous embodiment, but in parallel with a segment 400′ which comprises several cells in series. The basic idea remains the same: the DC-DC converters will deliver (source) or subtract (sink) the difference 1001 in current to or from the associated segments (that is, groups of cells). The needed power for this is subtracted from the PV system (in case additional current is delivered to the cells) or delivered to the PV system (in case current is subtracted from the associated cells).

In the embodiment shown in FIG. 10, the supplementary power units 1006 are DC-DC converters. The output current lout from the converter is the difference current 1001; the input current Iin to the converter, shown at 1003, 1004 and 1005, is sourced from (or to) the PV system. If more than one converter is operating, the net Input current is 1002, which is sourced from (or to) the PV system.

In another embodiment, a supplementary power unit such as a DC-DC converter can be applied in parallel with a complete module.

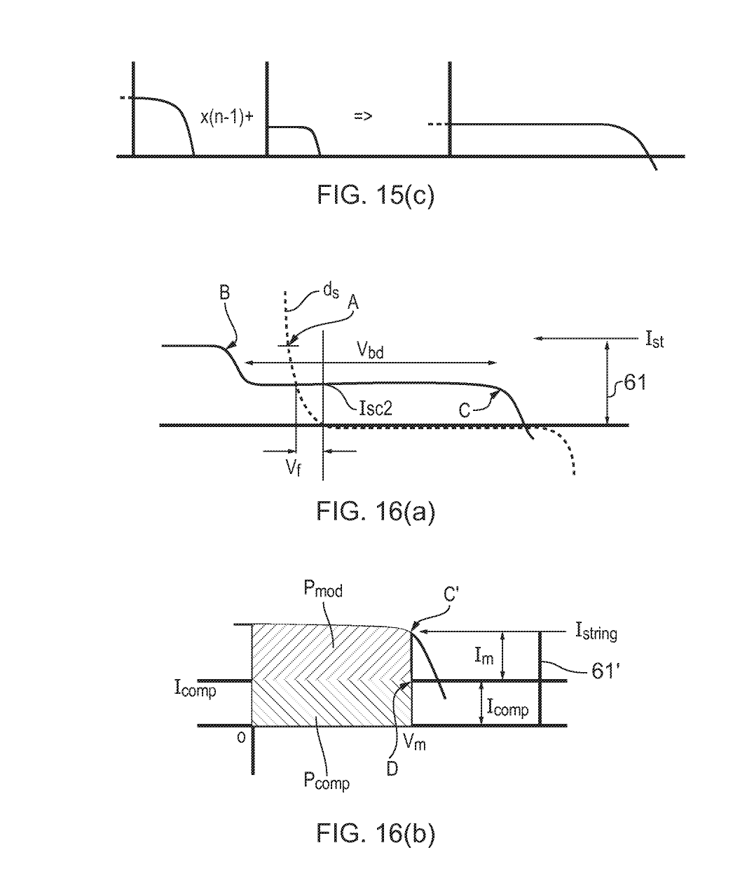

Pictorially, then, the sub-unit with the lower current is operating as shown in FIG. 16(b). The module including the lower-current cell is enabled to operate at it's maximum power point C′, (where is delivers current Im, at voltage Vm), by virtue of the fact that supplementary power unit or current compensator provides additional current Icomp, such that the total current is equal to the string current Istring. The compensator is then supplying power (at point D) of Pcomp=Icomp*Vm, and the module (that is, the cells within the module or sub-unit) is supplying Pmod=Vm*Im.

As can be seen in FIG. 10, the series connection of the modules (or segments) remains in place. As a result, the bulk of the output power is delivered directly by the string and not by the delta DC-DC converters 1006.

This leads to the mentioned power-efficiency advantages relative to prior art systems in which all the power has to be fed through the DC-DC converters

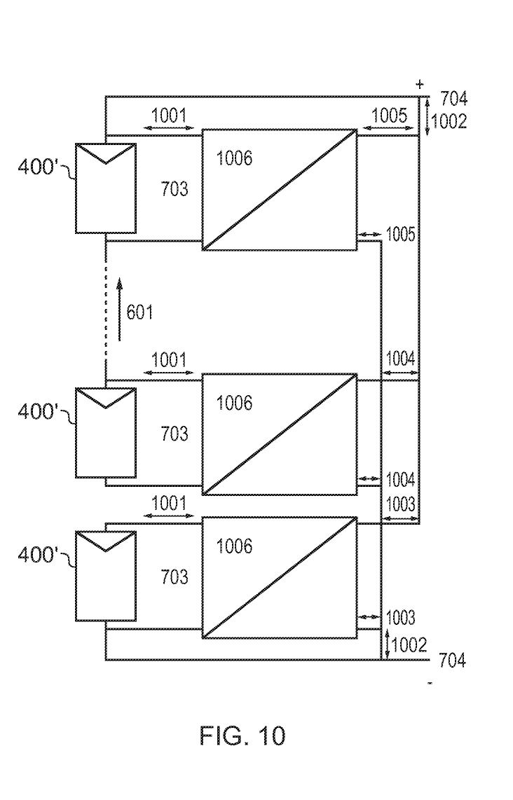

This is further illustrated in FIG. 11. FIG. 11 depicts the output powers of several modules (1, 2, . . . 12) in a string (1102), in which differences occur, under the approximation that the voltages of each of the modules is the same. The power 1101 delivered by the string is depicted at the bottom (split into that supplied by each module 1, 2 . . . 12), whereas the power converted through the delta converters (in the depicted case of a bidirectional implementation, a unipolar implementation is of course also possible) is depicted at the top. Downward arrows denote that the delta converter connected to the module subtracts or sinks current from the module, whereas upward arrows denote that the delta converter connected to the module adds or sources current to the module. The net result is that all modules behave as if they operate all at the same insolation level yielding the denoted average output power 1103. Since the differences in practice will be considerably lower than 100%, the bulk of the power delivered by the string will be considerably higher than the power converted by the delta converters. This has a positive impact on the cost and efficiency, as described above.

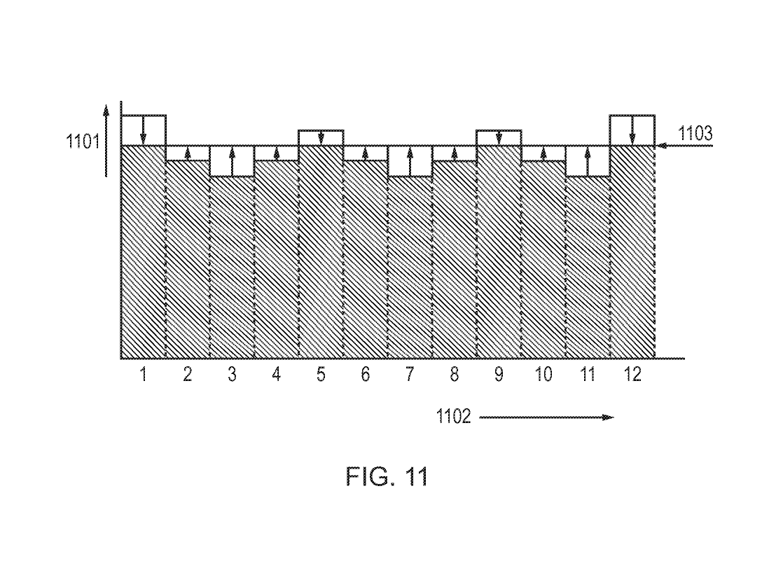

Various alternative embodiments can be used to implement the basic idea described above. First of all, in the embodiment of FIG. 10 the inputs to the delta converters are connected across the total string voltage. This requires that each delta converter needs to convert power between the module voltage level of e.g. 30 V (in case of a 60-cell module typical for many solar applications) and the string voltage level of e.g. 300 V (in case of 10 modules in series in a string). An alternative would be to generate an intermediate voltage centrally in the system from which all delta converters are supplied. The objective is to provide a lower-voltage solution for all delta converters in the system and having only one central high-voltage DC-DC converter. The fact that there is only one central DC-DC converter to convert the high string voltage to a lower intermediate voltage allows for optimizing its efficiency since its added cost has less impact on the total cost than that of the multitude of low-voltage DC-DC delta converters. This is depicted in FIG. 12, where only one string is shown. The embodiment of FIG. 12 is similar to that of FIG. 10, except that in this case, the inputs 1003, 1004, 1005 to the converters are not supplied by from the string voltage but from a central High Voltage (HV) DC-DC converter 1202, which itself is supplied by connections 1002 to the string voltage 704. In case of multiple parallel strings there will be one central HV DC-DC converter 1202 converting the string voltage into a suitable intermediate voltage for all module delta DC-DC converters 1201. The intermediate voltage could for example be in the same voltage range as the output voltage of the low-voltage DC-DC converters, e.g. 30 V for a 60-cell module. Alternatively, the intermediate voltage could be chosen on voltage-breakdown limitations of cost-effective IC technology, e.g. 100 V for automotive Silicon-on-Insulator (Sol) technology.

In order to control the current delivered or consumed by the delta converters, the use of a central control function is possible. This is depicted in

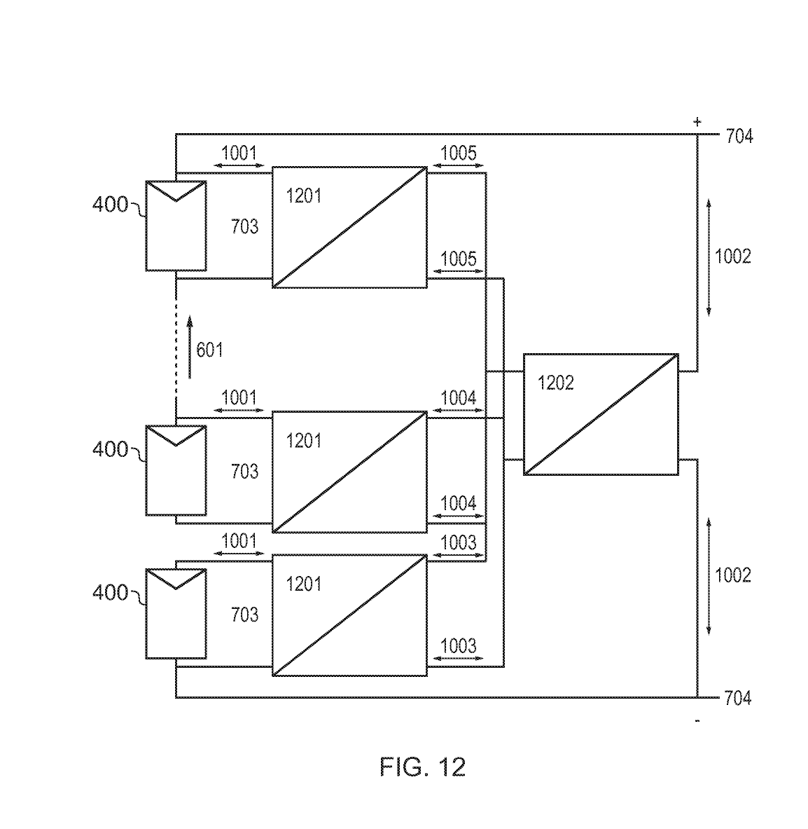

FIG. 13. Here all delta converters 1006 (only two shown for simplicity, connections to modules and string, whether or not via intermediate supply also left out for simplicity) are connected to each other via a communication bus 1301 that is also fed to a central control function 1302. Alternatively, the delta converters could also determine the current to be delivered or subtracted individually.

In order to ensure that the delta converters lead to a positive effect, the total output power of the PV system is monitored in the central MPPT algorithm. This algorithm still resides inside the central inverter. The information of this MPP may be fed back to the delta converters, optionally via some form of central control function overseeing the delta-converter operation to find the optimum operating point. The controller may also provide that number of active compensators is a minimum. In order to provide a maximum output the number of active compensators is preferably minimum. Using e.g. logical assumptions, an optimized output can be provided by determining a minimum set of active compensators.

As mentioned above, a particularly preferred type of supplementary power unit for use in embodiments of the invention, is a DC-DC converter. Conventional DC-DC converters may be used, as will be well-known to those skilled in the art. The converter is preferably a switched-mode converter, and may be a uni-directional converter such as a flyback converter, or a bi-directional converter such as a half-bridge converter.

In electronic engineering, a DC-DC converter is an electronic circuit, which converts a source of direct current (DC) from one voltage level to another. It is a class of power converter. A bi-directional converter offers power conversion between both a first voltage to a second voltage and a second voltage to a first voltage. The converter typically utilizes common magnetic components such as a transformer and a filter inductor and dual-function built-in diodes across transistors. Such a converter also typically utilizes a bridge converter, a push-pull converter, and a boost converter. A switched-mode power supply (also switching-mode power supply and SMPS) is an electronic power supply unit (PSU) that incorporates a switching regulator. While a linear regulator maintains the desired output voltage by dissipating excess power in a pass power transistor, the switched-mode power supply switches a power transistor between saturation (full on) and cutoff (completely off) with a variable duty cycle whose average relates to the desired output voltage. It switches at a much higher frequency (tens to hundreds of kHz) than that of the AC line (mains), which means that the transformer that it feeds can be much smaller than one connected directly to the line/mains. Switching creates a rectangular waveform that typically goes to the primary of the transformer; typically several secondary-side rectifiers, series inductors, and filter capacitors provide various DC outputs with low ripple.

The main advantage of this method is greater efficiency because the switching transistor dissipates little power in the saturated state and the off state compared to the semiconducting state (active region). Other advantages include smaller size and lighter weight (from the elimination of low-frequency transformers which have a high weight) and lower heat generation due to higher efficiency. Disadvantages include greater complexity, the generation of high-amplitude, high-frequency energy that the low-pass filter must block to avoid electromagnetic interference (EMI), and a ripple voltage at the switching frequency and the harmonic frequencies thereof.

The flyback converter is a DC-DC converter with a galvanic isolation between the input and the output(s). More precisely, the flyback converter is a buck-boost converter with the inductor split to form a transformer, so that the voltage ratios are multiplied with an additional advantage of isolation. When driving for example a plasma lamp or a voltage multiplier the rectifying diode of the Buck-Boost converter is left out and the device is called a flyback transformer. It is equivalent to that of a buck-boost converter, with the inductor split to form a transformer . Therefore the operating principle of both converters is very close: When the switch is on, the primary of the transformer is directly connected to the input voltage source. This results in an increase of magnetic flux in the transformer. The voltage across the secondary winding is negative, so the diode is reverse-biased (i.e. blocked). The output capacitor supplies energy to the output load. When the switch is off, the energy stored in the transformer is transferred to the output of the converter.

There are two configurations of a flyback converter in operation: In the on-state, the energy is transferred from the input voltage source to the transformer (the output capacitor supplies energy to the output load). In the off-state, the energy is transferred from the transformer to the output load (and the output capacitor). The flyback converter may form an isolated power converter, in which case the isolation of the control circuit is also needed. The two prevailing control schemes are voltage-mode control and current-mode control. Both require a signal related to the output voltage. There are three common ways to generate this voltage. The first is to use an optocoupler on the secondary circuitry to send a signal to the controller. The second is to wind a separate winding on the coil and rely on the cross regulation of the design. The third is to use the reflected output voltage on the primary side during the flyback stroke (primary sensing).

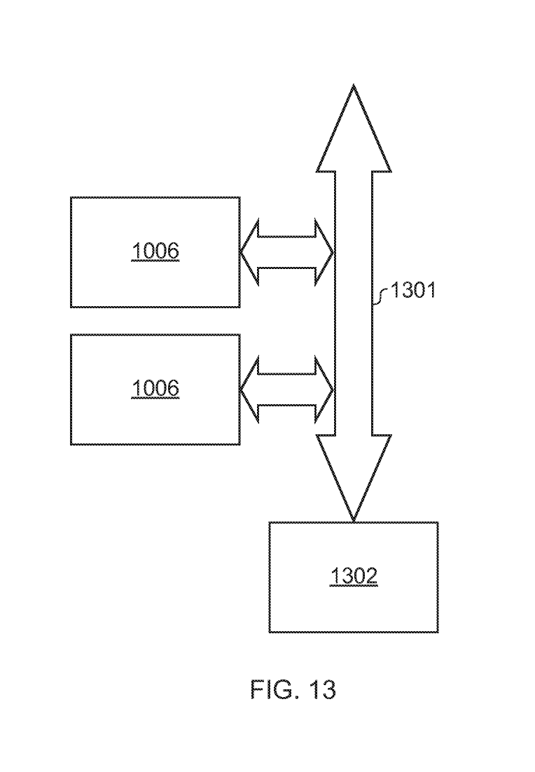

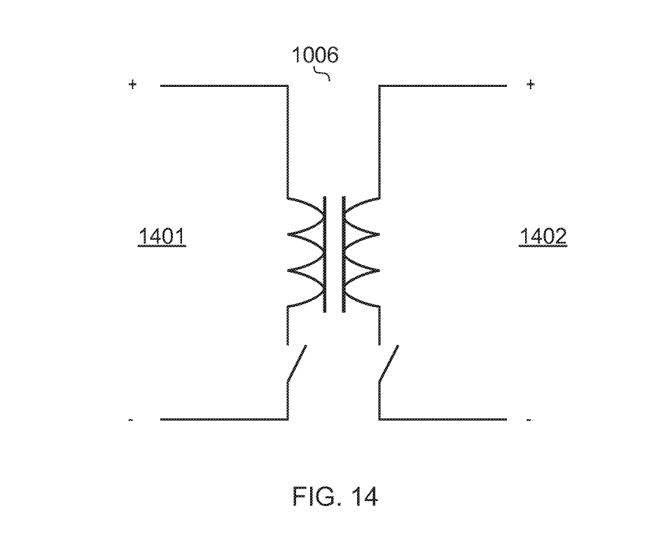

A known basic embodiment of a bidirectional DC-DC converter (1006) that allows for different input 1401 and output terminal 1402 voltage levels due to the isolation obtained using a transformer/coupled set of coils is depicted in FIG. 14. Unidirectional versions can be derived from this figure by replacing one of the switches by a diode. Other, more detailed embodiments are possible. For example, without limitation, a specific example of a unidirectional converter is a flyback converter that can only deliver current to modules. This is a suitable embodiment for many applications, since in most cases the number of shaded modules will be low compared to the number of modules in the sun, increasing the likeliness that only for a few modules current needs to be delivered. Depending on the construction of the solar module, the flyback converter can be given multiple outputs, e.g. one output per section normally bridged by a bypass diode. This multi-output converter, or one converter per bypass section, may conveniently be placed in the junction box, either in combination with the existing bypass diodes or replacing them.

The following supplementary information, with which the skilled person will be familiar, will be of use in gaining a better appreciation of the present invention:

Types of solar cells: On today's market, two distinct types of cells can be distinguished. First of all, several types of single-junction and multiple-junction crystalline-silicon-based solar cells exist. Secondly, various types of thin-film solar cells are being introduced. The single-junction mono or multi-crystalline silicon-based solar cells dominate today's market (>80% market share) and have a power conversion efficiency of up to roughly 20%, with a theoretical maximum of 27%. Multi-junction cells, based e.g. on III-V semiconductors and multiple stacked PN junctions tuned at different wavelengths of light achieve efficiencies of 40% and higher, but these are currently used only in niche markets such as in space or with highly concentrated sunlight and in laboratories and still have to find their way to mass production at an acceptable cost level. Various thin-film technologies together take up to 20% of today's market. Examples of thin-film technologies are CdTe (Cadmium Telluride) and CIGS (Copper Indium Gallium Selenium). Efficiencies are generally below 10%, but costs are significantly lower than for crystalline-silicon-based cells. Thin-film technologies are expected to take an increasing market share at the cost of crystalline cells in the future, but both are expected to co-exist in future markets.

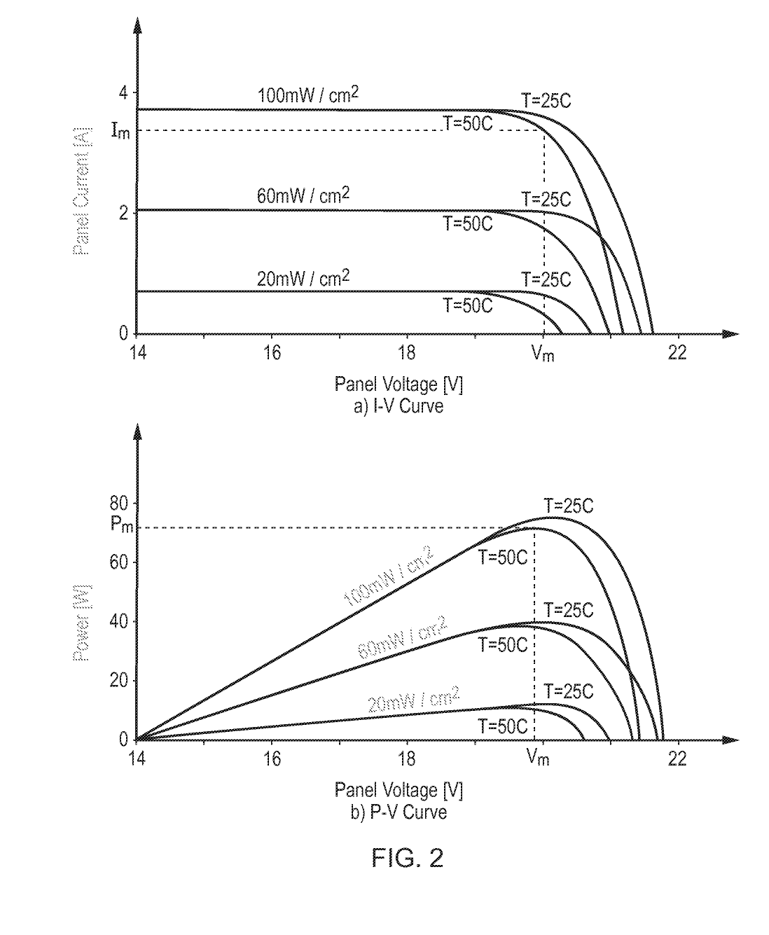

Types of PV systems: FIG. 3 illustrates various types of PV systems: basically, four groups of applications can be distinguished: stand-alone systems, residential systems, commercial systems, and solar plants.

In a stand-alone PV system there is no connection to a mains grid. Such a system is mainly applied in road signage or in places where there is no infrastructure, such as remote locations or in developing countries. Power ranges are typically from 100 W-1 kW. In most cases, a single module will fulfill a desired function, where e.g. a lead-acid battery is charged during the day and either DC loads are connected at night or an inverter is used to boost e.g. a 12 V DC up to e.g., 110 Vrms AC to accommodate AC loads up to a few 100 W.

In residential applications solar modules are placed in an appropriate series-parallel fashion to achieve a desired voltage level at an input of the DC/AC inverter that connects a PV system to a grid. Practical inverters have a certain DC input voltage range within which Maximum Power Point Tracking (MPPT) can be performed for all modules simultaneously. A voltage range of the PV system under all practical conditions (anticipated light and temperature variations) should be chosen such that it always falls within a required input range of an inverter. This determines the number of modules placed in series. Depending on a required output power, several strings of modules can be placed in parallel. Practical powers for residential systems range from 1-10 kW. Energy obtained from a residential system is used in the house on which roof it is placed. Optionally, excess power can be delivered back to a mains grid. In the latter case, a two-way electricity meter is needed to calculate the net cost of electricity. A typical module used in residential applications contains 60 cells in series. At 1000 W/m² and with an MPP current of roughly 7.5 A (which is 7% lower than an insolation current lins of 8 A) and an MPP voltage of 0.5 V per cell, the output power is 60*7.5 A*0.5 V=225 W when operated at MPP. With a typical surface area per solar cell of 15 cm*15 cm, this module is roughly 1.5 m2 in size, which is e.g. still practical for installers. As an example, a 5 kW residential PV system would then contain roughly 22 modules, occupying a surface area of roughly 33 m².

Commercial PV systems are scaled-up versions of residential systems, e.g. placed on roofs of large buildings and exploited commercially. The owner of the building usually signs a contract with a utility company about an amount of electrical energy to be delivered over an agreed time span. Similar remarks with regards to series and parallel connections of modules can be made as for residential systems. Practical power ranges are from 10 kW to 1 MW.

Solar plants are typically operated by utility companies to generate electrical energy for large numbers of houses. Solar plants are placed in large fields and deserts and occupy large areas. (Partial) shading is much less likely to appear now and also pollution will occur less or during a shorter time span than for residential and commercial applications, since operators will clean modules when applicable. This is a fundamental difference with residential and commercial systems, where maintenance is less likely to occur. Powers are in the order of at least 1 MW or larger. Again, similar remarks hold for the number of panels placed in series/parallel. In any case, large amounts of strings are placed in parallel, since a practical input range of a central inverter is still 100s of V, implying e.g. 20 modules of 30 V each in series with e.g. 4 kW per string.

From the above, it will be immediately apparent to the reader that embodiments of the invention may benefit from one or more of the following differences, relative to prior art systems:

Some prior-art solutions comprise a sigma converter. On the contrary, embodiments of the present invention relate to “delta converters”. Such a delta converter adds or subtracts (that is, sources or sinks) additional current on a cell or group of cells basis, thereby compensating for differences in output between cells or groups of cells, hence the name “delta” converter. A delta converter is typically either dimensioned for a lower power level than the sigma converter, since generally only differences in power need to be converted as opposed to full power. Alternatively, depending on the differences that one wants to compensate for, a delta converter can be dimensioned for full power. In that case, however, a lower efficiency is less critical to the total energy lost than in case of the sigma converter, since this lower efficiency is then only applicable to a limited number of converters.

Since delta converters only convert differences in power, their efficiency has less impact on total power lost. As a result, a larger part of available solar energy may be effectively delivered to an input of the central inverter. Therefore, one can realize a converter with a lower efficiency and still achieve positive effects. As a result, more energy is delivered over time in case of shading conditions when compared to a solution with sigma converters.

Delta converters can be switched on when needed only, i.e. only when they have a positive effect on total output power. The sigma converter, however, always needs to be active.

When retro-fitting a delta-converter solution to existing PV installations, all existing connections can be left intact and e.g. only junction boxes need to be replaced with boxes containing (a) delta converter(s) and possibly wiring needs to be added to supply these converters. Thus, due to reduced requirements, a delta converter can be realized cheaper and smaller than a sigma converter; due to an acceptable lower efficiency of a delta converter, its cost can be reduced even further compared to a sigma converter; due to the fact that a delta converter is not always active, its lifetime will be enhanced significantly compared to a sigma converter, and due to a higher efficiency of a total solution comprising one or more converters, significantly more energy will be obtained over time when used in shaded conditions. This increases economical attractiveness of the embodiments for installed PV systems.

From reading the present disclosure, other variations and modifications will be apparent to the skilled person. Such variations and modifications may involve equivalent and other features which are already known in the art of photovoltaics, and which may be used instead of, or in addition to, features already described herein.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination.

The applicant hereby gives notice that new claims may be formulated to such features and/or combinations of such features during the prosecution of the present application or of any further application derived therefrom.

For the sake of completeness it is also stated that the term “comprising” does not exclude other elements or steps, the term “a” or “an” does not exclude a plurality, a single processor or other unit may fulfil the functions of several means recited in the claims and reference signs in the claims shall not be construed as limiting the scope of the claims.

1. A photovoltaic unit comprising;
a first sub-unit, and
a second sub-unit series-connected with the first sub-unit,
wherein the first sub-unit and second-sub-unit each comprise one of a single solar cell and a series-connected plurality of solar cells, and
wherein the first sub-unit further comprises a supplementary power unit connected in parallel with the respective solar cell or plurality of solar cells.

2. A photovoltaic unit as claimed in claim 1, wherein the supplementary power unit comprises at least part of a DC-DC converter.

3. A photovoltaic unit as claimed in claim 2, wherein the DC-DC converter is configurable to at least one of source and sink current in parallel with the first sub-unit's respective solar cell or plurality of solar cells.

4. A photovoltaic unit as claimed in claim 1, wherein the first sub-unit is a module comprising between 4 and 72 solar cells.

5. A photovoltaic unit as claimed in claim 1, wherein the first sub-unit comprises between 18 and 24 solar cells.

6. A photovoltaic unit as claimed in claim 2, wherein the second sub-unit further comprises a second supplementary power unit.

7. A photovoltaic unit as claimed in claim 6, wherein the second supplementary power unit comprises at least part of a second DC-DC converter.

8. A photovoltaic unit as claimed in claim 7, wherein the second DC-DC converter is configurable to at least one of source and sink supplementary current.

9. A photovoltaic unit as claimed in claim 2, wherein the DC-DC converter is a switched-mode converter.

10. A photovoltaic unit as claimed in claim 2, wherein the DC-DC converter is a bidirectional converter.

11. A photovoltaic unit as claimed in claim 10, wherein the bidirectional converter is a half-bridge converter.

12. A photovoltaic array comprising a plurality of photovoltaic units as claimed in claim 1.

13. A method of operating a photovoltaic unit comprising a first sub-unit comprising at least one solar cell, a second sub-unit series-connected with the first sub-unit and comprising at least one solar cell, and a supplementary power unit connected in parallel with the at least one solar cell of the first sub-unit,
the method comprising:
determining a difference between a photo-generated current produced by the first sub-unit and a photo-generated current produced by the second sub-unit , and
controlling the supplementary power unit to supply current in dependence on the difference between the photo-generated current produced by the first sub-unit and the photo-generated current produced by the second sub-unit.

14. A method as claimed in claim 13 wherein the supplementary power unit is controlled to source current when the photo-generated current produced by the first sub-unit is less than the photo-generated current produced by the second sub-unit and to sink current when the photo-generated current produced by the first sub-unit is greater than the photo-generated current produced by the second sub-unit.

15. A method as claimed in claim 13, further comprising
determining a maximum power operating point of the first sub-unit whilst the supplementary power unit is not supplying current;
determining a maximum power operating point of the second sub-unit whilst the supplementary power unit is not supplying current, and
controlling the supplementary power unit to either source or sink current such that at least one of the first and second sub-units operates closer to its respective maximum power operating point than it does when the supplementary power unit is not supplying current.

16. A method as claimed in claim 15, wherein the step of controlling the supplementary power unit to either source or sink current such that at least one of the first and second sub-units operates closer to its respective maximum power operating point than it did when then supplementary power unit is not supplying current comprises controlling the supplementary power unit to either source or sink current such that each of the first and second sub-units operates substantially at its respective maximum power operating point.

17. A method as claimed in claim 13, wherein the photovoltaic unit comprises a further sub-unit comprising at least one solar cell and a further supplementary power unit connected in parallel with the at least one solar cell, which further sub-unit is series connected with the first and second sub-unit, the method further comprising controlling the further supplementary power unit to supply current in dependence on a photo-generated current of the further sub-unit.

18. A method as claimed in claim 13, wherein the photovoltaic unit comprises a plurality of sub-units, each of which comprises at least one solar cell, and a supplementary power unit connected in parallel with the at least one solar cell, wherein each supplementary power unit is controlled such that each at least one solar cell operates substantially at its maximum power operating point.

19. A method as claimed in claim 18, wherein each supplementary power unit is controlled such that a sum of the photo-generated current from the sub-unit and the current supplied by the respective supplementary power unit is substantially equal to an average of the photo-generated currents of the sub-units when none of the supplementary power units are supplying current.

20. A method as claimed in claim 18, wherein a total power supplied by the supplementary power units is substantially zero.

21. A controller configured to operate a method according to claim 13.
